(19) United States
(12) Patent Application Publication
(10) Pub. No.: US 2016/0035238 A1
(43) Pub. Date: Feb. 4, 2016

(54) NEURAL ADAPTIVE LEARNING DEVICE USING QUESTIONS TYPES AND RELEVANT CONCEPTS AND NEURAL ADAPTIVE LEARNING METHOD

(71) Applicant: EDUCLOUD CO. LTD., Seoul, NY (US)

(72) Inventors: Sang-Ho WON, Yancheon-gu Seoul (KR); Gang-Wook KIM, Mapo-gu Seoul (KR)

(21) Appl. No.: 14/774,271

(22) PCT Filed: Mar. 14, 2014
(86) PCT No.: PCT/KR2014/002199

§ 371 Date: Sep. 10, 2015

(30) Foreign Application Priority Data
Mar. 14, 2013 (KR) 10-2013-0027503

(51) Int. Cl. G09B 7/04; G09B 19/02; G09B 5/02

(52) U.S. Cl. CPC G09B 7/04; G09B 5/02; G09B 19/02

(57) ABSTRACT

Provided are a neural adaptive learning device using question types and relevant concepts and a learning method using the same, the device being capable of: storing curriculum, chapters, question types, problem types, problems, concepts and a relationship between the concepts; providing learning content to a user by using the stored data; connecting a learning history of each user for each problem in association with a chapter, a question type, a problem type and one or more concepts so as to extract a problem to be provided to a user by a neural adaptive method according to a rule defined for each of a plurality of learning levels on the basis of a mutually connected structure; adjusting the priority of a plurality of question types; and providing a concept cloud map for learning.

### TECHNICAL FIELD

The present invention generally relates to a neural adaptive learning device and a neural adaptive learning method, using question types and relevant concepts. More particularly, the present invention relates to a neural adaptive learning device and method using question types and relevant concepts, which enable a learner to autonomously understand the content of question types necessary for learning and to improve the learner's ability to solve problems connected to the question types and problems related to the concept, by providing adaptive learning content.

This application claims the benefit of Korean Patent Application No. 10-2013-0027503, filed Mar. 14, 2013, which is hereby incorporated by reference in its entirety into this application.

### BACKGROUND ART

To acquire knowledge and to check the knowledge, problem-based learning (PBL) and problem-based assessment are widely used by learners. Via a learner's solution to a worksheet, such methods have the following intentions: reporting achievement of the learning process, retraining learners, and examining efficiency of the current learning process.

Construction of an item pool is a commonly used method to prepare a worksheet for assessment. In other words, to make a worksheet, problems are selected from the item pool storing multiple problems, depending on the scope of learning, a difficulty level, and a chapter.

However, in the case of a learning assessment method based on item pools, the assessment is performed in a range of the chapter embraced by the problem. This is due to the fact that metadata of a problem is limited to information about a chapter including the problem and information corresponding to the difficulty level of the problem.

On the other hand, a chapter including a certain problem may cover various concepts. In this case, a learner has different degrees of comprehension and achievement for each of the concepts within a single chapter, but a conventional learning device and method do not consider such aspects. As a result, customized learning cannot be provided solely by distributing marks for each question and adding the marks in the chapter assessment and problem solving process. Therefore, it is difficult to improve the learner's understanding through such an approach.

In the United States, new learning methods are being implemented for mathematical education, and learning processes are changing. Common Core State Standards (CCSS), which is a common curriculum designed by mathematics educators and academics, has been promoted as a new learning standard so that students will be prepared for global competition. However, though the new learning process has been implemented, much effort and research are still required to develop a learning device or learning method appropriate for effective learning.

### DISCLOSURE

### Technical Problem

An object of the present invention is to enable a learner to understand concepts necessary for learning by focusing on question types and to develop a learner's logical thinking ability so as to solve a problem based on the understanding of the concepts. Also, the present invention intends to provide a learning method that enables each learner to autonomously learn logical concept structures of mathematics and the like.

Another object of the present invention is to improve a learner's ability to reason, thus enabling the learner to solve various transformed problems related to the concepts and types previously learned. Also, the present invention intends to provide a learning method customized to a user using an adaptive system by reflecting the degree of understanding based on a percentage of correct answers by the learner.

A further object of the present invention is to enable a learner to perform multi-dimensional and parallel learning. The present invention intends to provide a learning method to help a learner understand how learned concepts and other concepts are combined and transformed based on the problem according to the question type.

Also, the learning device and method according to the present invention intends to help a learner realize concepts and items at which he or she is weak and produce in the learner a sense of accomplishment when he or she learns something new.

### Technical Solution

A neural adaptive learning device, according to the present invention, displays learning content in a user's terminal connected by a network, processes the learning content provided to a user using a processor and a memory to assist the user in learning, and uses question types and relevant concepts. The neural adaptive learning device includes: a curriculum storing unit in which learning courses to be provided to a user are stored, the learning courses each being linked to multiple chapters for separating learning steps; a question type storing unit in which concepts necessary for learning and question types representing problems are stored in connection with the chapter; a problem type storing unit in which problem types are stored in connection with the question type; a problem storing unit in which problems are stored in connection with the problem types; a concept storing unit in which concepts are stored in connection with the problems; a concept map storing unit in which a relation between the concepts is stored; a learning history storing unit in which a learning history for each user is stored; and a processing unit for providing learning content to the user using data stored in the curriculum storing unit, the question type storing unit, the problem type storing unit, the problem storing unit, the concept storing unit, the concept map storing unit, and the learning history storing unit, wherein the user's learning history of the problem is connected with the chapter, the question type, the problem type, and one or more of the concepts, and wherein the processing unit includes: an adaptive problem extracting unit in which a problem to be provided to a user is extracted according to a rule for multiple learning levels each, which is established based on an interconnected structure in the question type storing unit, the problem type storing unit, the problem storing unit, the concept storing unit, and the concept map storing unit; a question type priority adjusting unit in which a priority of the multiple question types to be provided to the user is adjusted according to the user's learning history stored in the learning history storing unit; and a cloud map output unit that provides a cloud map to the user's terminal, using a concept and a relevant concept extracted from the concept storing unit and the concept map storing unit.

Also, a neural adaptive learning method according to the present invention displays learning content in a user's terminal connected by a network and processes and provides the learning content using a processor and a memory to assist the user in learning. The neural adaptive learning method provides a learning method using a learning device including a curriculum storing unit in which learning courses to be provided to a user are stored, the learning courses each being linked to multiple chapters for separating learning steps; a question type storing unit in which concepts necessary for learning and question types representing problems are stored in connection with the chapter; a problem type storing unit in which problem types are stored in connection with the question type; a problem storing unit in which problems are stored in connection with the problem types; a concept storing unit in which concepts are stored in connection with the problems; a concept map storing unit in which a relation between the concepts is stored; a learning history storing unit in which a learning history for each user is stored; and a processing unit for providing learning content to the user using data stored in the curriculum storing unit, the question type storing unit, the problem type storing unit, the problem storing unit, the concept storing unit, the concept map storing unit, and the learning history storing unit.

The neural adaptive learning method includes: connecting, by the learning history storing unit, the user's learning history of the problem with the chapter, the question type, the problem type, and one or more of the concepts; adaptively extracting, by the adaptive problem extracting unit, a problem, to be provided to the user, from the problem storing unit, according to a rule for multiple learning levels, each of which is established based on an interconnected structure in the question type storing unit, the problem type storing unit, the problem storing unit, the concept storing unit, and the concept map storing unit; adjusting, by the question type priority adjusting unit, a priority of the multiple question types according to the user's learning history stored in the learning history storing unit; and providing, by the cloud map output unit, a cloud map to the user's terminal, using a concept and a relevant concept extracted from the concept storing unit and the concept map storing unit.

### Advantageous Effects

According to the present invention, departing from a conventional learning process for remembering a solution, a user may acquire a deep understanding of mathematics through a concept-based approach. Problems may be conceptually categorized, and a concept common to both of the problems may be studied. Accordingly, a user may solve a problem via understanding of the concept, though the problem is new to the user. Thereby, learning effects can be improved by systematically relating a problem and a concept, a root concept and a sub-concept, a concept and another concept, and a problem and another problem. Also, by using accumulated learning history as big data, an adaptive learning method may be provided to a user.

The present invention provides a new online neural adaptive learning platform. The present invention relates to an adaptive and intelligent learning system, which may provide an individualized adaptive program for mathematics via computers, based on a neural network model for logical thinking. Data collected in a previous step is used to determine a next step, and is also used to determine the previous step.

The present invention helps develop students' logical thinking, and analyzes a user's pattern to determine the degree of understanding question types and concepts, by collecting records of learning different types of problems. Also, this data is used to determine the difficulty level of problems in a next step.

Through a relation among a question type, a problem type, a problem, and a concept, the present invention may provide a learning device and method that are not only comprehensive and intuitive but also dynamically adapted to a user's level and learning record, thus enabling a student to be aware of his or her weak points and helping him or her study effectively.

When a user persistently uses a learning device and learning method program, according to the present invention, data about a concept, a problem type, and the degree of understanding a question type can be accumulated. Also, the user's understanding is evaluated and learning materials customized to the user can be provided. Through an intelligent visual dictionary, the meaning of a concept may be understood, and a relation between concepts may be easily realized because relevant concepts are provided with the concept. When clicking one of the concepts, a user may figure out at a glance how the concept is related to other concepts. When another relevant concept is retrieved, as the relevant concept is displayed with previous concepts, it is possible to retrieve from the top-level concept to the most fundamental concept.

Also, the learning device and method may improve learning effects by helping a user understand a relation between problems, a concept related to a problem, and a relation between concepts. A cloud map, which in the case of this invention is a personalized mathematics encyclopedia, can be used. A concept, another concept that is selected based on the learning record of the question type related to the first concept, and a relation between the two concepts can be provided. The user may freely move to a desired concept from a difficult concept or to an easy concept by only a few clicks. Also, the learning device and method may visually display the degree of understanding of the concept, clearly show the user's weak points to suggest further study, and may provide different problems and concepts according to the user. As various levels of mathematics problems are provided depending on a user's demands, students may study step-by-step at their own pace.

Using a multi-dimensionally accumulated learning history, the learning device and method predict a student's grade and help the student study effectively to achieve his or her goal. Also, a teacher may create personalized curriculum for a class. The teacher may provide content appropriate for a student's needs, and may check each student's progress and understanding.

Also, using an extensively defined DB, a learning method can be easily and quickly designed for any learning process of any country. The present invention enables teachers to effectively teach mathematics, which may ease the financial burden of tutoring and supplemental education, and may raise student's mathematics achievement.

A user may learn concepts necessary for further learning, and develop logical thinking for solving problems. Also, the present invention may provide a learning method in which learners may autonomously acquire an understanding of logical concept structures of mathematics and the like. Also, the present invention may improve learners' logical thinking, thus producing a student capable of solving various kinds of transformed problems related to a learned concept.

Also, the present invention continuously develops a cloud map by reflecting understanding of a concept based on a percentage of correct responses provided by a learner in a test situation. Accordingly, the present invention may provide the learner with a customized learning method. The present invention may provide a learning method that assists learners in understanding how a learned concept and other concepts are combined and varied according to a problem.

### DESCRIPTION OF DRAWINGS

FIG. 1 illustrates a relation between terminals and a learning device according to an embodiment of the present invention;

FIG. 2 illustrates an internal configuration of a learning device according to an embodiment of the present invention;

FIG. 3 illustrates a main configuration of a processing unit according to an embodiment of the present invention;

FIG. 4 simply illustrates a link structure between data, according to an embodiment of the present invention;

FIG. 5 illustrates a link structure between a chapter and a question type, according to an embodiment of the present invention;

FIG. 6 illustrates a link structure among a question type, a problem type, and a concept, according to an embodiment of the present invention;

FIG. 7 illustrates a flowchart corresponding to a process example of an adaptive learning method using a question type and a relevant concept, according to an embodiment of the present invention;

FIG. 8 illustrates an example in which a main page of a curriculum is displayed according to an embodiment of the present invention;

FIG. 9 illustrates an example of a page on which a recommended type of learning step is displayed according to an embodiment of the present invention;

FIG. 10 illustrates an example of a page on which a recommended type of learning step is displayed, according to an embodiment of the present invention;

FIG. 11 illustrates an example of a page on which a standard question is displayed, according to an embodiment of the present invention;

FIG. 12 illustrates an example of a recommended type of learning page for a question type according to an embodiment of the present invention;

FIG. 13 is a flowchart illustrating an adaptive learning process in a Smart Task step, according to an embodiment of the present invention;

FIG. 14 illustrates a rule for extracting a problem on a step basis in a Smart Task step, according to an embodiment of the present invention;

FIG. 15 illustrates an example of a page in a diagnosis step according to an embodiment of the present invention;

FIGS. 16 and 17 illustrate an example of a page on which a cloud map link function is displayed according to an embodiment of the present invention;

FIG. 18 illustrates an example of a page in a recommended order learning step according to an embodiment of the present invention;

FIG. 19 illustrates a rule for arranging question types in a recommended order learning step according to an embodiment of the present invention;

FIG. 20 illustrates a view in which an order of question types is changed in a recommended order learning step according to an embodiment of the present invention; and

FIG. 21 illustrates an example of a page in a recommend order learning step according to an embodiment of the present invention.

### BEST MODE

The present invention will be described in detail with reference to the accompanying drawings. In the following description, it is to be noted that, when the functions of conventional elements and the detailed description of elements related with the present invention may make the gist of the present invention unclear, a detailed description of those elements will be omitted. The embodiment of the present invention described hereinafter is provided for allowing those skilled in the art to more clearly comprehend the present invention. Therefore, it should be understood that the shape and size of the elements shown in the drawings may be exaggeratedly drawn to provide an easily understood description of the structure of the present invention.

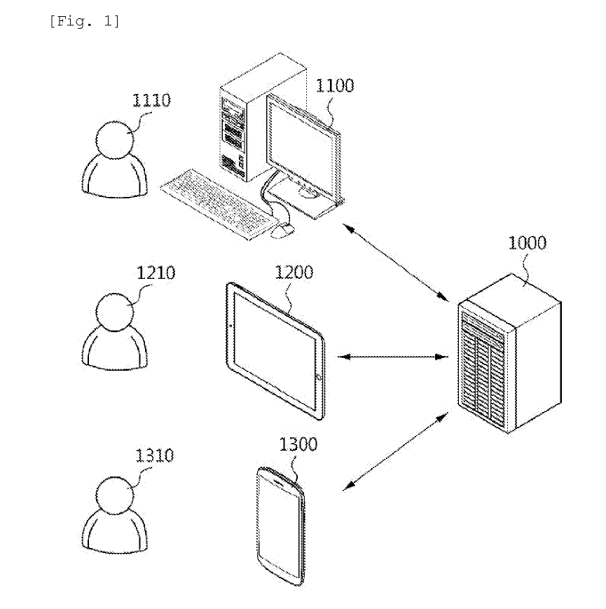

FIG. 1 illustrates a relation between terminals and a learning device according to an embodiment of the present invention. FIG. 1 illustrates a learning device 1000 according to an embodiment of the present invention, multiple users 1110, 1210, and 1310, and multiple terminals 1100, 1200, and 1300. The learning device 1000, generally in the form of a server, is connected to the multiple terminals 1100, 1200, and 1300 through a network. The network may be a wireless or wired network, and may be any network capable of data communication between the server and the terminals.

In FIG. 1, a user 1110 connects to the learning device 1000 through a network, using a PC 1100; a user 1210 connects to the learning device 1000 through a network, using a tablet PC 1200; and a user 1310 connects to the learning device 1000 through a network, using a smart phone 1300. The kinds of terminals and the number of users are an example, and the learning device 1000 may be a complex server connected to multiple devices.

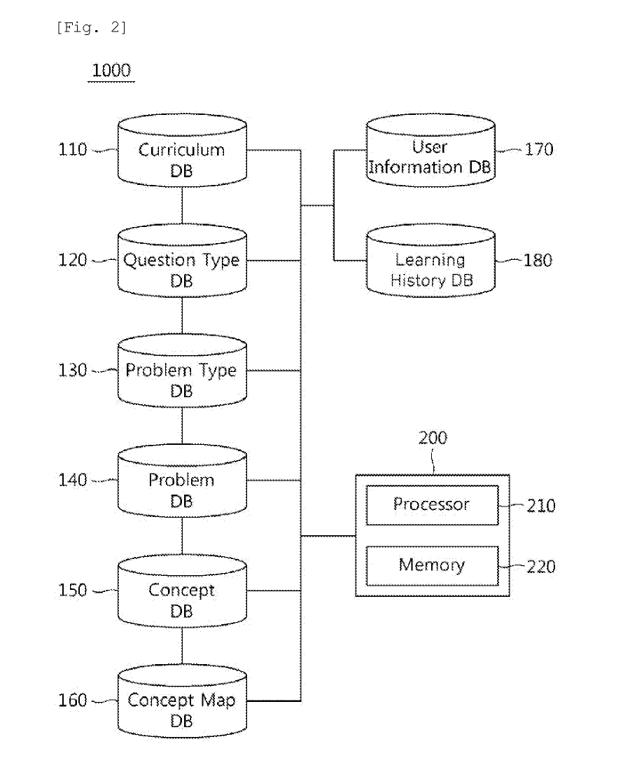

FIG. 2 illustrates an internal configuration of a learning device according to an embodiment of the present invention. The learning device 1000 includes: a curriculum DB 110 that is a curriculum storing unit for storing curriculums, which are kinds of learning courses provided by the device, and for storing chapters, which are separated according to learning steps in each of the curriculums; a question type DB 120 that is a question type storing unit for storing question types, which represent both concepts and problems required for learning each chapter; a problem type DB 130 that is a problem type storing unit for storing problem types necessary for each of the question types; a problem DB 140 that is a problem storing unit for storing problems for learning; a concept DB 150 that is a concept storing unit for storing concepts; a concept map DB 160 that is a concept map storing unit for storing a relation between concepts; a user information DB 170 that is a user information storing unit for storing user information; and a learning history DB 180 that is a learning history storing unit for storing learning histories of each user. These DBs can be configured by combining or separating two or more of them according to need. These DBs may be commonly called a DB unit.

A processing unit 200 provides a user with adaptive learning content by using data stored in the DBs. The processing unit 200 is configured to include a processor 210 and a memory 220. The memory 220 stores a program for operating the learning device, and may permanently or temporarily store data necessary for operating the learning device.

The curriculum storing unit 110 stores curriculums that are kinds of learning courses, and chapters divided according to the learning steps in each of the curriculums. The curriculums may be regarded as a learning course, for example, SAT, Algebra, High School Proficiency Assessment (HSPA), Geometry, Middle School courses, High School courses, Advanced courses, and the like. A user needs to select a learning course to use the learning device. Each learning course stores chapters that are divisions of the course, and a chapter name is assigned to each of the chapters. The chapter name, for example, “Expressions, equations, and functions”, represents content to be learned by a user in the corresponding chapter.

The question type storing unit 120 stores multiple question types that represent concepts and problems necessary for learning each chapter. A question type name, for example, “Evaluating numerical expressions”, represents relevant concepts and problems. A question type level for indicating a difficulty level of learning is assigned for each question type, and may be divided into 4 levels, including Basic, Easy, Hard, and Harder. Question types linked to a chapter preferably include various question type levels so as to provide adaptive learning.

The problem type storing unit 130 stores multiple problem types necessary for each question type. Multiple problem types are established for each question type and multiple problems including a representative problem and a similar problem are grouped for each question type, whereby adaptive learning can be provided.

The problem storing unit 140 stores many problems for learning, for example, mathematics problems. These problems each contain problem content, which explains the problem itself, and a solution. Also, the problems may include a prompt for presenting the principle of the solution, which explains the solution in stages by linking it to a concept. When the prompt is included, because a user may study the principle of a solution step-by-step while consulting the prompt rather than immediately referring to the answer to learn the solution of the problem, the degree of understanding may be improved in comparison with learning by referring to only the solution. Also, as the prompt is linked to a relevant concept, the user may learn the relevant concept using a cloud map.

A concept storing unit 150 stores concepts corresponding to each node of a cloud map. These concepts each include: a concept name for intuitively explaining content of the concept to a user; a concept type for distinguishing the category of the concept; and a concept explanation for explaining the content of the concept in detail. The concept name is, for example, “properties of equality”. The concept type includes a definition, a theorem, a proof, and a method. The concept type enables a user to realize the category of the concept, and there may be two or more concepts that have the same concept name and different concept types. The concept means a certain term necessary for learning and may be categorized into a definition, a theorem, a proof, and a method. Consequently, learning can be performed based on a concept regarding a problem rather than based on the problem.

Also, the concept explanation according to the embodiment of the present invention may be provided differently depending on a user's level. Even for the same concept, according to the user's level, an easier concept explanation is provided to a low-level user, whereas a deep concept explanation is provided to a high-level user. Accordingly, it is possible to provide the concept explanation adaptive to the user's level. Because the concepts stored in the concept storing unit 150 are linked to the problems of the problem storing unit 140, a concept involved in each problem may be provided. Conversely, a problem involved in each concept may be provided.

In the concept map storing unit 160, a relation between the concepts stored in the concept storing unit 150 is defined and stored. The concept map storing unit 160 is a main component for representing a cloud map because it stores a relation between the concepts to implement the cloud map. As the concepts in the concept storing unit 150 correlate with each other according to the data in the concept map storing unit 160, the concept map storing unit may be referred to a relational concept map storing unit 160.

Also, because the concept map storing unit 160 not only stores a relation between the concepts but defines a relational order between the concepts, it may be referred to as a concept pivot storing unit. A single concept has either a previous concept or a next concept, or both, as a relation with another concept. The previous concept and the next concept may be provided in plural numbers. For example, the previous concept of the present concept, “linear function”, is “function”, and the next concept may be defined as “linear regression”. The previous concept should be understood in advance to understand the present concept, and the next concept is understood after understanding the present concept. In this example, the previous concept of the “linear regression” may be “function”.

This relation between the concepts may define a learning step based on a concept, and may be adaptively changed depending on a learning curriculum, a user's level, and the user's degree of understanding. As the relation between the concepts is adaptively changed, a concept map customized to a user may be provided and the learning effect can be raised.

Also, linking strength is set between the concepts. The concepts, in which a correlation with another concept is defined, may have a strong linking relation or a weak linking relation. Because this linking strength can be changed depending on a user's level or the degree of understanding, an adaptive concept map may be provided. For example, when the user's degree of understanding a certain concept is high, the linking strength between the corresponding concept and another concept may be weaker. When the linking strength is less than a predetermined value, the concept may be excluded from a cloud map to avoid repeatedly presenting the content to the learner.

The user information storing unit 170 stores information about multiple users using a learning device. Not only a user's ID and password to log in to the learning device, but also various kinds of information such as a curriculum list, a level, a score, and the like may be stored.

The learning history storing unit 180 stores a learning history on a user basis. The learning history includes learning records based on a chapter, a question type, a problem type, a problem, and a concept. When a certain problem is learned, a record representing that the problem has been learned and a record indicating whether the answer is right or wrong are stored. Also, the learning history can be stored for a problem type, a question type, and concepts, which are linked to the corresponding problem. If a certain problem is linked to two concepts, when a user learns the problem, the learning history is stored for the linked question type and for the linked two concepts. Also, as a user learns a problem, the degree of understanding the different items that are linked to the problem is also stored. Therefore, the degree of understanding may be realized from various points of view and this has a great effect on learning. In addition, the degree of understanding may be stored only for the problem, and the degree of understanding the different items may be realized through the correlation.

For example, when 5 problems connected to a single concept are studied and 3 right answers are submitted, the degree of understanding the concept becomes 60%. As a result, in all the pages displaying the corresponding concept, the user's degree of understanding the concept may be explicitly displayed or may be displayed when a pointer is over the concept name. Similarly, when a problem included in a certain question type is learned, a learning history for the question type is updated and the degree of understanding the question type can be evaluated. Also, using the correlation, an additional problem related to the corresponding problem may be studied according to need, to raise understanding thereof. This is possible because problems are linked to a concept as well as a problem type and a question type, according to the embodiment of the present invention.

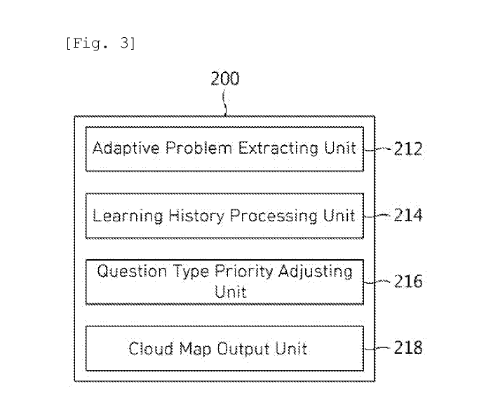

FIG. 3 illustrates a main configuration of a processing unit 200 according to an embodiment of the present invention. The processing unit 200 serves to provide an adaptive learning method to a user, using data stored in the various DBs. The processing unit 200 includes: an adaptive problem extracting unit 212 for adaptively extracting a problem, to be provided to a user, from the problem storing unit 140; a learning history processing unit 214 for processing a learning result and for storing it in the learning history storing unit 180, whenever a user learns a problem; a question type priority adjusting unit 216 for adjusting the priority of multiple question types included in each chapter; and a cloud map output unit 218 for outputting a cloud map in a user's terminal, using a concept and a relevant concept extracted from the concept storing unit 150 and the concept map storing unit 160. The concrete operations and roles of each unit will be described in detail hereinafter.

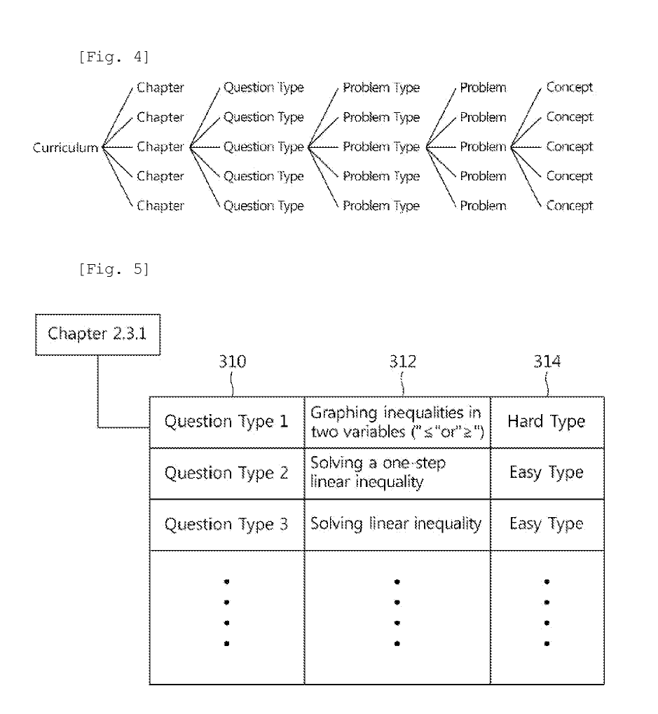

FIG. 4 simply illustrates a link structure between data according to an embodiment of the present invention. Referring to FIG. 2, a curriculum stored in the curriculum storing unit 110 is linked to multiple chapters. Also, a chapter is linked to multiple question types stored in the question type storing unit 120. A question type is linked to multiple problem types stored in the problem type storing unit 130, and each problem type is linked to multiple problems stored in the problem storing unit 140. Each problem is connected with one or more concepts stored in the concept storing unit 150. Consequently, when a certain problem is selected, one or more concepts related to the problem, a relevant problem type, question type, chapter, and curriculum are determined. By this link structure, for example, when a user studies a problem, not only the degree of understanding the concept but also the degree of understanding the problem type, question type, chapter, and curriculum may be simultaneously updated.

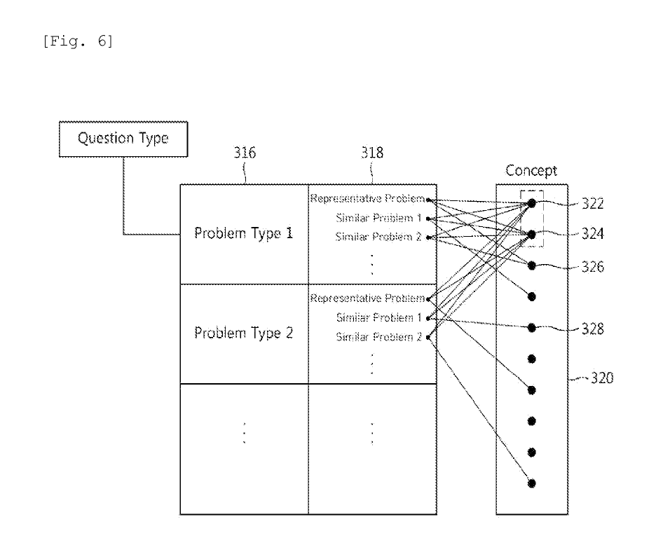

FIG. 5 illustrates a link structure between a chapter and a question type, according to an embodiment of the present invention. As described above, a chapter is linked to multiple question types. In FIG. 5, a specific chapter, “Chapter 2.3.1” is linked to multiple question types 310 including Question Type 1, Question Type 2, and Question Type 3. Also, a question type name 312, which represents content of the question type, and a question type level 314, which indicates the level of the question type, is assigned to each of the question types. The question type 310, the question type name 312, and the question type level 314 can be stored in the question type storing unit 120 of FIG. 2. To provide a user with an adaptive learning method, a chapter is linked to multiple question types having various levels.

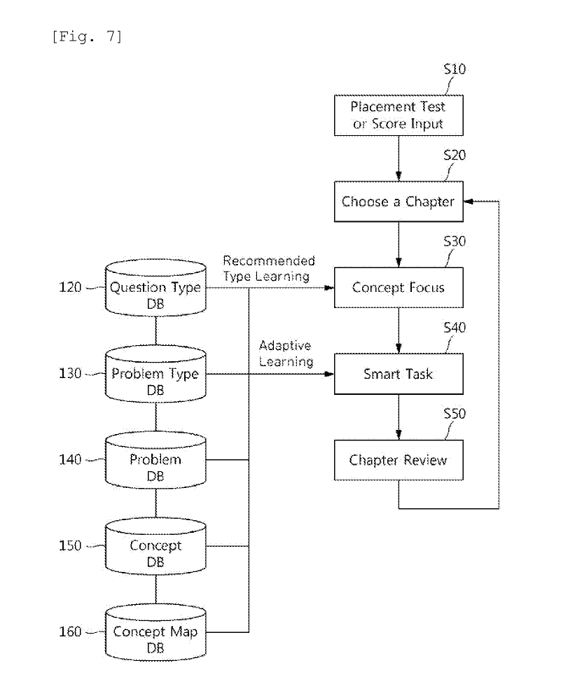

FIG. 6 illustrates a link structure among a question type, a problem type, and a concept, according to an embodiment of the present invention. As described above, a question type is linked to multiple problem types in which an order is assigned. In FIG. 6, a certain question type is connected with multiple problem types 316 such as Problem Type 1, Problem Type 2, and Problem Type 3. The problem type is stored in the problem type storing unit 130 of FIG. 2. The order of the problem types is set according to a loophole index, and the problem type arranged rearward has a higher loophole index. A high loophole index may mean that the difficulty level of the problem type is high in comparison with other problem types in the same question type. As learning progresses, the problem type arranged rearward is prone to be extracted, so the problem having the higher loophole index is learned.

Also, each problem type is linked to multiple problems 318. The multiple problems include a representative problem, which represents the problem type, and a plurality of similar problems that are similar to the representative problem and corresponds to the problem type. Because a problem is extracted based on a structure in which a question type is linked to multiple problem types and each problem type is linked to a single representative problem and multiple similar problems, an adaptive learning method can be provided. In the early stage in learning, a representative problem is presented, and as learning progresses, relevant similar problems are provided to improve the efficiency of learning. The problems are stored in the problem storing unit 140 of FIG. 2.

Also, each problem is connected with one or more concepts 320. Representative Problem of Problem Type 1 is linked to three concepts 322, 324, and 326. In other words, the Representative Problem of Problem Type 1 is related to the concepts 322, 324, and 326. Likewise, Similar Problem 1 of Problem Type 2 is linked to three concepts 322, 324, and 328. The concept linked to the problem may have a duplicated part and unduplicated part.

As illustrated in FIG. 6, the problems included in a question type are equally connected with the concepts 322 and 324. Because these concepts 322 and 324 are the concepts to which the problems included in the question type are commonly linked, they may be referred to a common concept.

As problems included in a single question type are problems in the same question type, they should have common ground. In the embodiment of the present invention, the problems are confirmed to have common ground by being linked to a common concept. However, not all the problems are linked to common concepts and some of them cannot be linked to some of the common concepts. Similarly, problem types may have a common concept. Therefore, in the embodiment of the present invention, problems are grouped into a problem type, based on a concept linked to the problems, and problem types are grouped into a question type.

On the other hand, as each problem is linked to a concept, a user may check the concept related to the problem and may study the corresponding concept if he or she wants to do so. For example, when a user who studies Similar Problem 1 of Problem Type 2 checks the relevant concept and intends to study the concept 322, a concept name, a concept type, and a concept explanation of the concept 322, which are stored in the concept storing unit 150, may be extracted for studying. Also, by learning Similar Problem 1 of Problem Type 1, which is another problem connected to the concept 322, the degree of understanding the concept may be evaluated and improved. In other words, because a problem and a concept are closely connected with each other, a user may experience multidimensional learning and may simultaneously acquire understanding of both the problem and the concept. Also, as a learning history can be updated or stored for a problem, a concept, a problem type, and a question type, at the same time, the learning effect of the learning device can be improved.

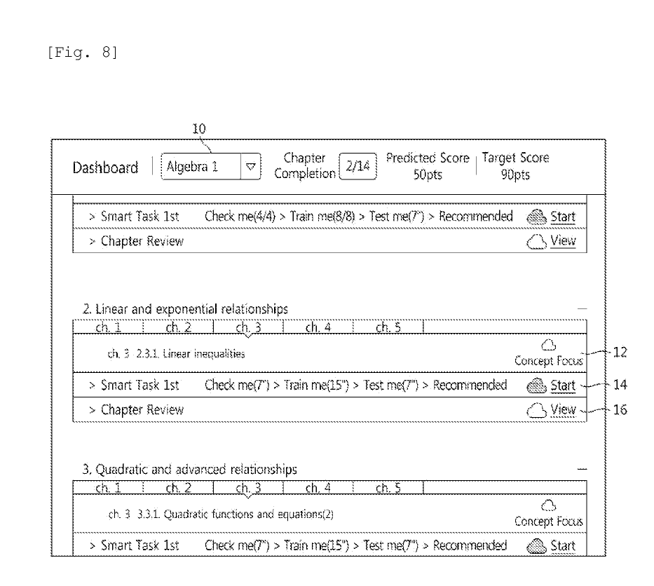

FIG. 7 illustrates a flowchart corresponding to a process example of an adaptive learning method using a question type and a relevant concept, according to an embodiment of the present invention. The process of FIG. 7 is performed after a user has completed a connecting process including login and has selected a curriculum. Available curriculums or curriculums purchased by a learning device are displayed in a screen of the user's terminal, and the user selects a curriculum among them to enter a main page of the curriculum.

When a user learns the corresponding curriculum for the first time, the user solves a problem provided by a placement test and obtains a score, or sets a target score by directly inputting the score, to evaluate the user's level at step S10. The placement test is for determining the start point of learning by diagnosing the current level of the user. Instead of the placement test, the user may select his or her current level or may directly input a corresponding score. A target score set by such a process indicates the user's level and it is one of the important criteria for providing an adaptive learning method. According to the target score, the difficulty level of a provided problem is different. Especially, the target score is one of the indexes to extract a problem to be provided to the user at a Smart Task step (S40).

When a user's target score is set at step S10, a chapter to be studied in the corresponding curriculum is selected at step S20. When a user selects a chapter, the process progresses into step S30, which is a recommended type of learning step. Step S30 is a Concept Focus step according to the embodiment of the present invention, and is a step for learning a recommended type corresponding to the selected chapter. At this step, the user may learn a concept and basic principle, corresponding to the selected chapter.

When learning of the recommended type of the corresponding chapter has been completed, the process progresses into step S40, which is a Smart Task step. The Smart Task step is an adaptive learning step in which problems for improving the user's understanding are adaptively extracted and provided according to a rule established based on an interconnected structure in a question type storing unit 120, a problem type storing unit 130, a problem storing unit 140, a concept storing unit 150, and a concept map storing unit 160. This step is performed by an adaptive problem extracting unit 212 of FIG. 3.

While a user repeatedly practices at step S40, which is a Smart Task step, the user may enter step S50 according to need. Also, the user may enter step S50 when completing learning because his or her degree of understanding is sufficiently improved or may enter step S50 during the learning. Then, the user performs a Chapter Review step to review the problems learned in the corresponding chapter. At the Chapter Review step, the previously solved problems and the explanation about the problem, stored in the learning history unit, can be checked again. The problem and the explanation, which are extracted at steps S30 and S40 and provided to the user, can be reviewed when each of the steps is terminated.

Then, by returning to step S20 and selecting another chapter, the user performs the same process as in the previous chapter. When all the chapters defined for one curriculum have been learned, the learning method according to the embodiment of the present invention is terminated. As the user carries on the above-described process, the user may naturally improve the degree of understanding concepts and problems. The steps after step S20 are described in detail referring to page examples.

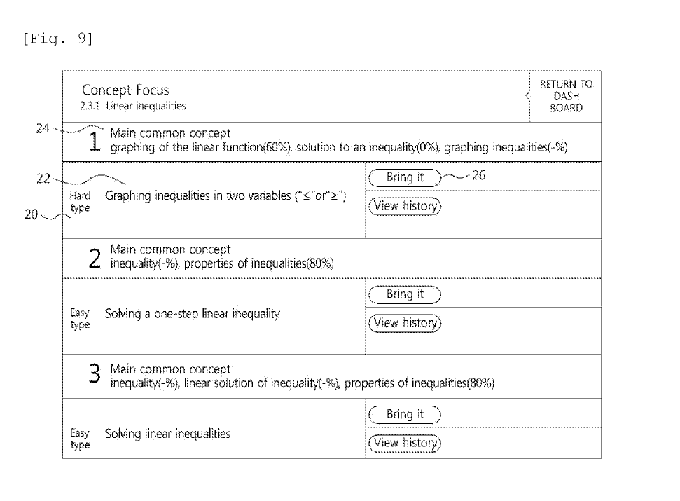

FIG. 8 illustrates an example in which a main page of a curriculum is displayed according to an embodiment of the present invention. An item 10 represents a curriculum that a user selects, and this example shows the case in which “Algebra 1” curriculum is selected. A user's target score is displayed in the right upper corner, and a predicted score indicating a current level of the user is displayed in the left side of the target score. Because the predicted score is obtained by predicting a user's final score based on the current state, it helps in intuitively understanding the current level of the user and in raising the motivation to learn. Also, an item indicating each chapter, such as “ch. 1”, “ch. 2”, and the like, can be displayed in different colors according to the degree of understanding. The main page of the curriculum enables a user to see the learning progress of the corresponding curriculum at a glance.

In the window at the lower part, multiple chapters included in a curriculum are displayed. Also, for each of the chapters, links for performing steps S30, S40, and S50 of FIG. 7 are provided. This example is explained in the “Linear inequalities” chapter, which is chapter 2.3.1. When a user clicks a Concept Focus link 12, the process progresses into a recommended type learning step (S30) of FIG. 2; when the user clicks a Smart Task link 14, the process progresses into a Smart Task step (S40) of FIG. 2; and when the user clicks a Chapter Review link 16, the process progresses into a Chapter Review step (S50) of FIG. 2. The process in which the user performs a recommended type learning step by clicking the Concept Focus link 12 is described.

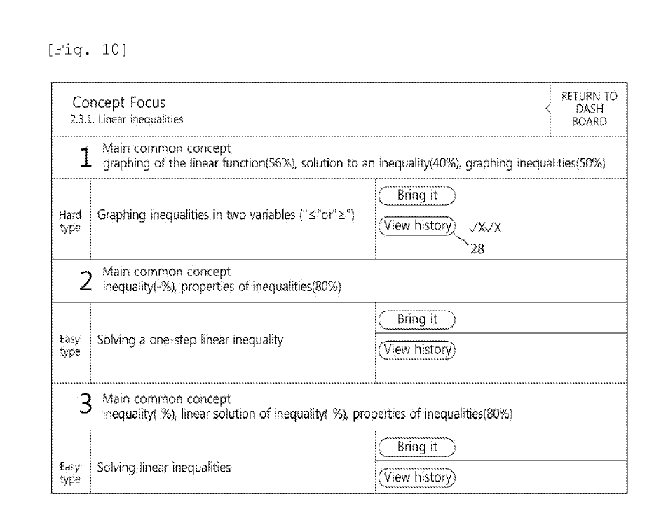

FIG. 9 illustrates an example of a page on which a recommended type learning step is displayed according to an embodiment of the present invention. The recommended type learning step is set for each chapter, and because the link of chapter 2.3.1 is clicked to enter the step, question types linked to the corresponding chapter are displayed on the page. A question type name 22 of the first question type is “Graphing inequalities in two variables”. A question type level 20 of the question type is Hard. For each question type, a main common concept 24, which is an important common concept among the above-described common concepts of the question types, is displayed.

A user's degree of understanding is displayed for each concept. Though a user starts learning of an exemplified chapter for the first time, the degree of understanding the concept “graphing of the linear function” is displayed as 60%. This may mean that the user has submitted 60% of correct answers for the problems linked to this concept in another question type, in another chapter, or in another curriculum. In other words, according to the embodiment of the present invention, the user's degree of understanding a certain concept is synthetically evaluated in the learning device. As a result, if a user consistently has used the learning device, even when learning a course for the first time, the user can check in advance his or her degree of understanding on a concept basis, or on a question type basis. This may be helpful in determining the priority of learning and enables effective learning.

On the other hand, by selecting one from common concepts 24 displayed on the page, the process may also progress into a cloud map that helps a user understand the corresponding concept. Accordingly, the user's degree of understanding a common concept of the corresponding question type can be intuitively realized and learning of the concept can be immediately performed. Furthermore, problems linked to the concept can be provided, thus improving the understanding of the concept.

Also, when clicking “Bring it” button 16 to be offered a recommended type and to study it, a user may learn the recommended type for a question type. “Bring it” is for learning basic knowledge about the corresponding question type, and it is a recommended type of learning step according to the question type, in which recommended type problems included in the question type are learned. In the recommended type learning step according to the question type, a problem is extracted from among problems related to the corresponding question type, and is provided to a user. To extend basic knowledge through various problems, it is desirable to sequentially extract a problem from each problem type linked to the question type. Also, a problem can be provided by selecting a problem's difficulty level based on a target score. The difficulty level of the problem can be determined, for example, based on the state in which a problem type arranged rearward has a higher difficulty level among problem types linked to the question type.

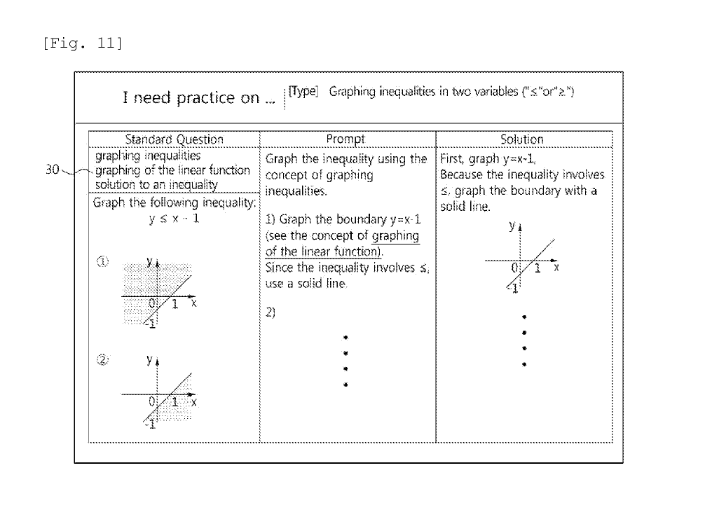

FIG. 10 illustrates an example of a page on which a recommended type learning step is displayed according to an embodiment of the present invention. FIG. 10 illustrates a state in which the recommended type learning step according to the question type is completed and the process is returned to the recommended type learning step in the screen. It is confirmed that the degree of understanding the common concept is changed on the page. This means that the user has learned the problems linked to the common concepts and the degree of understanding the concept is updated according to the percentage of correct answers. Also, whether the answers of the latest 4 problems are right or wrong is displayed in the View history item 28, and the user may review the recently learned problems by clicking the View history item 28.

The reason whether the answers of the latest 4 problems are right or wrong is displayed as follows. A pattern of correct and incorrect answers for a specific type of problems has been analyzed for tens of thousands of students. As a result, if all the answers of the latest 4 problems are correct, it may be statistically determined that learning of the specific type of problems has been completed. Accordingly, at the “Bring it” step, whether the answer is right or wrong is displayed only for the latest 4 problems, and when a user consecutively submits the correct answers for the latest 4 problems, “mastered”, which indicates the completion of learning, is displayed to notify the user that the user no longer needs to learn the recommended type for the corresponding question type.

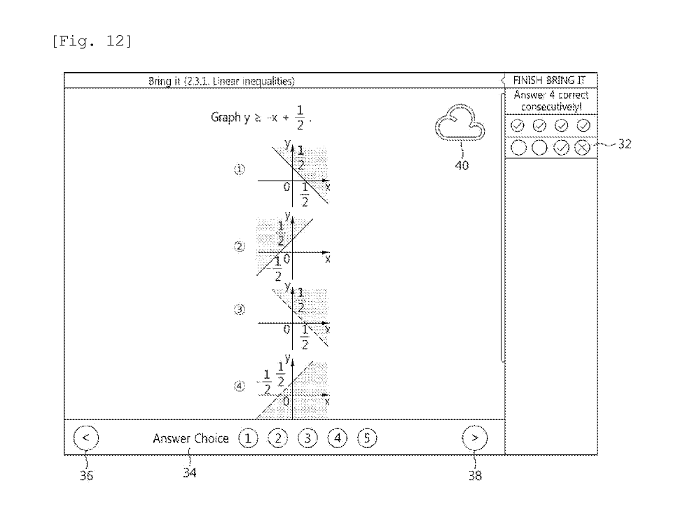

FIG. 11 illustrates an example of a page on which a standard question is displayed, according to an embodiment of the present invention. FIG. 11 shows a standard question page that is provided to teach basic knowledge of a corresponding question type when the “Bring it” step is started. A representative problem of Problem type 1 in the corresponding question type is presented and a common concept of the question type is provided in the upper part as in the previous page. Also, in the right side of the standard question, a prompt for presenting a principle of the solution, which explains the solution in stages by linking it to a concept, is provided. The underlined “graphing of the linear function” is one of the concepts necessary for understanding the problem and provides a link to the cloud map as in other pages.

Also, in the right side of the prompt, a solution for the problem is provided. After learning a representative type through study of the standard question of the corresponding question type, a user enters the next step to learn a recommended type problem according to the question type.

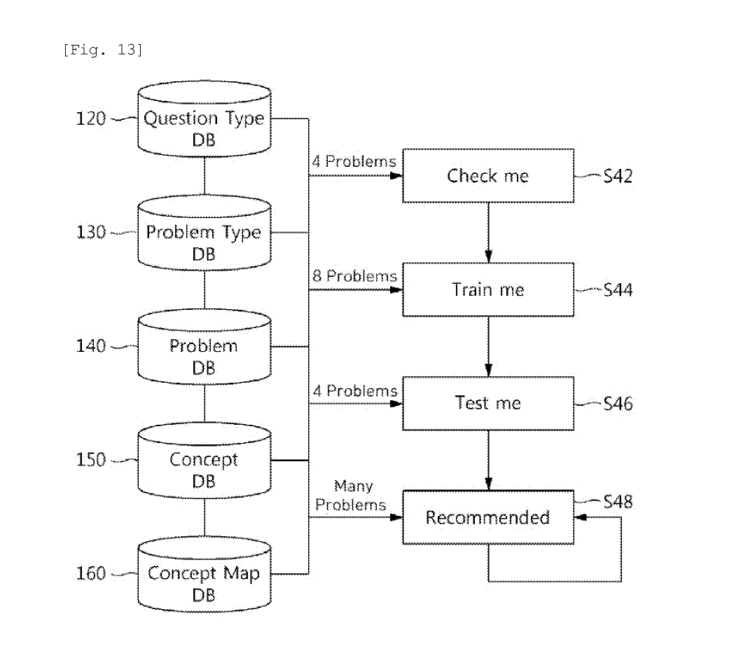

FIG. 12 illustrates an example of a recommended type learning page for a question type according to an embodiment of the present invention. In the left side, a problem is provided and an answer section 24 is displayed in the lower part. In the left and right sides of the answer section 24, a previous problem button 36 and a next problem button 38 are displayed, respectively. At the right upper side of the problem, a cloud map link button 40 is provided to allow checking the concepts linked to the problem. Also, in the right upper corner of the page, a right/wrong answer display section 32, in which whether the answers of the latest 4 problems are right or wrong is displayed.

A user may continuously study until consecutively submitting right answers for 4 problems, or may interrupt studying. Also, it is possible to study the relevant concept through the cloud map link button 40. When the recommended type learning for each question type is completed, the process progresses into a Smart Task step (S40) of FIG. 2. To progress into the Smart Task step, the Smart Task link 14 of FIG. 8 may be clicked.

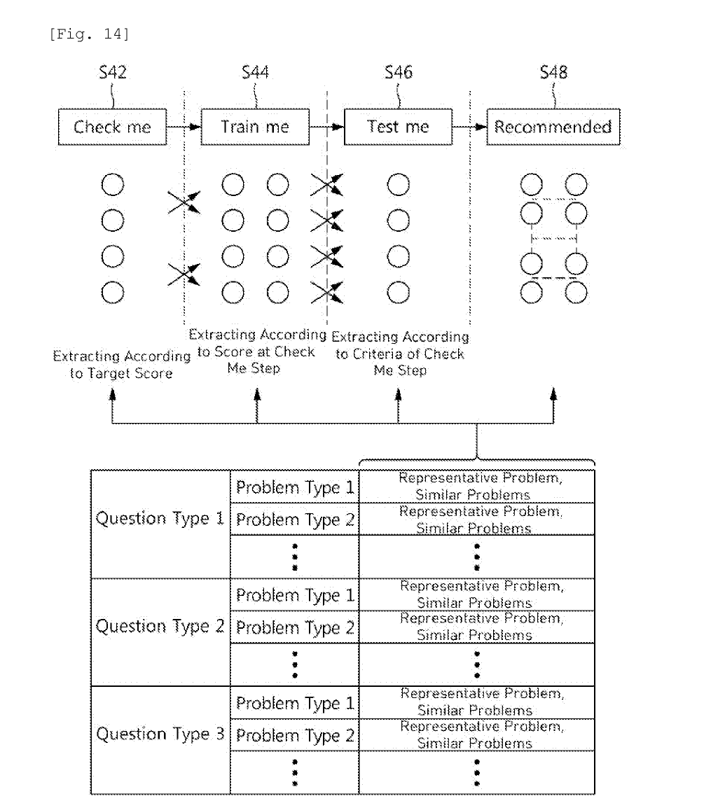

FIG. 13 is a flowchart illustrating an adaptive learning process in the Smart Task step, according to an embodiment of the present invention. As described in FIG. 7, in each step of the Smart Task step, a problem is adaptively extracted and provided according to a rule established based on an interconnected structure in a question type storing unit 120, a problem type storing unit 130, a problem storing unit 140, a concept storing unit 150, and a concept map storing unit 160. The Smart Task step intends to raise a user's degree of understanding through 3 steps of a process, which is a key sector of the adaptive approach.

The Smart Task step sequentially performs a Check me step

(S42), a Train me step (S44), a Test me step (S46), and a Recommended step (S48), and the steps are operated by being connected with each chapter. The Check me step (S42) is a diagnosis step in which 4 problems are adaptively extracted and provided. The Train me step (S44) is a processing step in which 8 problems are adaptively extracted and provided. The Test me step (S46) is a finishing step in which 4 problems are adaptively extracted and provided. The Recommended step (S48) is a recommended order learning step in which the number of the provided problems is not limited. Also, this step may be repeatedly performed.

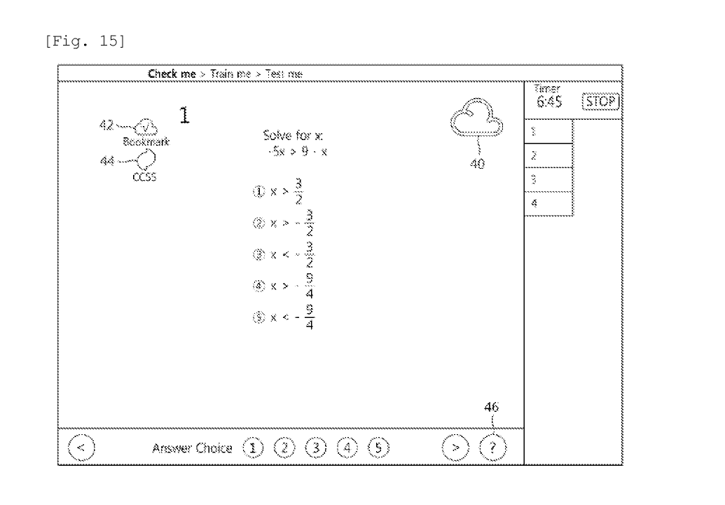

FIG. 14 illustrates a rule for extracting a problem on a step basis in the Smart Task step, according to an embodiment of the present invention. In the lower part of the drawing, each of the multiple question types is linked to multiple problem types, and each question type is linked to a representative problem and similar problems. These are linked to a single chapter.

In the Check me step (S42), which is a diagnosis step, a problem is extracted according to a user's target score. This intends to adaptively provide a problem according to a user's level. The number of problems, to be extracted according to the question type level, is determined based on a target score, and problems are extracted according to the rule. In other words, based on a range of the target score, how many problems are extracted from which question type is defined as a rule. In the diagnosis step, 4 problems are provided, and in this case, for example, a rule may be defined as follows: when a target score is in a range of 61 to 80, 2 problems are extracted from a question type of which the level is easy, and 2 problems are extracted from a question type of which the level is hard. Also, in the diagnosis step, a problem is extracted from among representative problems of each question type. To make a user face various problems, problems are extracted from different question types of the corresponding chapter. The diagnosis step is for diagnosing at which question type a user is good or bad. When a user submits an incorrect answer for a problem, a question type from which the problem is extracted may affect the following processing step.

In the Train me step (S44), which is a processing step, problems are extracted according to a score of the diagnosis step (S42) that is a previous step. Because 4 problems are provided in the diagnosis step (S42), a level can be divided into 5 levels. Among 8 problems provided in the processing step, 4 problems are varied problems. The 4 problems are extracted in such a way that each of the 2 problems are extracted from each of the two question types in which incorrect answers are submitted at the diagnosis step (S42). This intends to provide an opportunity of relearning and to improve learning comprehension, by providing problems similar to the problem for which a user has submitted a wrong answer in the diagnosis step (S42). Also, because the processing step is a step for training, the varied problems are extracted from a problem type in the same question type, but it is desirable that the problem type is different from a problem type for which a wrong answer has been submitted.

If a user has submitted one wrong answer in the diagnosis step, 2 problems are extracted as varied problems from a corresponding question type. When the user has submitted only correct answers in the diagnosis step, it is not necessary to provide a varied problem. Therefore, according to the number of wrong answers in the diagnosis step, 4, 2, or 0 problems are extracted as varied problems, and the remaining problems are extracted according to a rule in which the number of problems, to be extracted according to the question type level, is determined based on a target score, as in the diagnosis step. As a score in the diagnosis step is higher, it is desirable to increase the number of problems to be extracted from the question type of which the level is high. The processing step is a step for providing problems for which a user needs to raise his or her degree of understanding. From a basic level to an advanced level, by providing a process adaptive to a user's level, personalized practice in which a concept is applied to a problem is provided.

The Test me step (S46), which is a finishing step, extracts a problem from the same problem type of the same question type of the problem extracted in the diagnosis step. By studying the same type of problems as in the diagnosis step, a user may check the learning effect of the processing step and may have an increased sense of accomplishment. Also, it is possible to check whether the user has mastered the problems of the previous step. Also, extracting problems of the same question type may mean sufficiently securing data to determine a priority in the following recommended order learning step. As mentioned above, when adaptive learning is terminated in the diagnosis step (S42), the processing step (S44), and the finishing step (S46), the learning history is stored and the process progresses into a recommended order learning step (S48) based on the stored learning history.

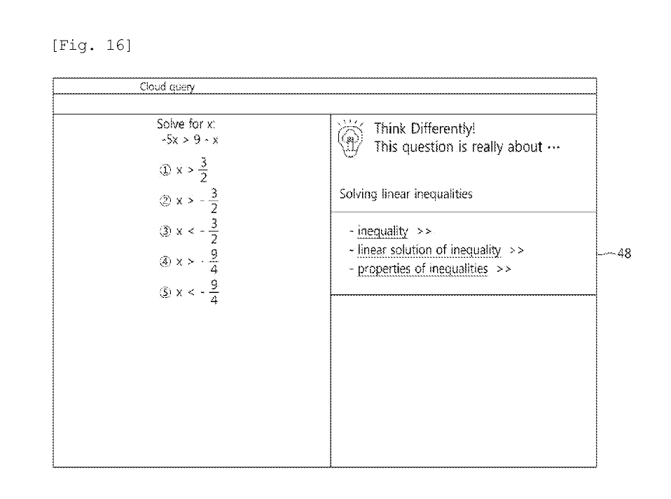

FIG. 15 illustrates an example of a page in a diagnosis step according to an embodiment of the present invention. According to the above-described rule, the extracted problem is provided, and a bookmark button 42 for bookmarking the corresponding problem and a CCSS button 44 for providing Common Core State Standards (CCSS) information are provided in the left side. A skip button 46 is a button for skipping the problem when it is difficult to select a correct answer, and a cloud map link button 40, which is also illustrated in FIG. 12, is provided to enable checking a concept linked to the corresponding problem.

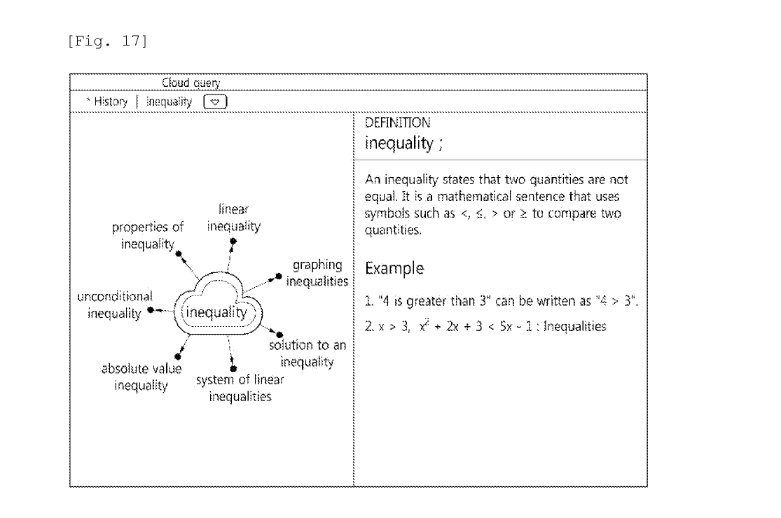

FIGS. 16 and 17 illustrate an example of a page on which a cloud map link function is displayed according to an embodiment of the present invention. When a user clicks a cloud map link button 40 of FIG. 15, concepts 48 linked to a corresponding problem are displayed with the problem. Among the displayed concepts 48, when a user wants to study the concept of “inequality” and clicks the concept, the page is converted to a page of FIG. 17.

In a state in which the selected concept, “inequality” is set to a current concept, the information of different concepts related to the current concept is visually displayed in a cloud map display window in the left side. Also, in a concept information window in the right side, “DEFINITION” corresponding to a concept type is displayed in the first line; “inequality” corresponding to a concept name is displayed in the next line; and a concept explanation is displayed below the concept name. By selecting a concept to learn, a user may be provided with a type and an explanation, which are related to the concept, and may understand basic knowledge about the concept. Also, for the different concepts displayed on the page, an explanation of a certain concept may be accessed by selecting the concept. After learning the concept, a user may return to a page of FIG. 15 again and may resume solving problems. Also, when the user wants to additionally learn the concept, it is possible to extract and study other problems linked to the concept.

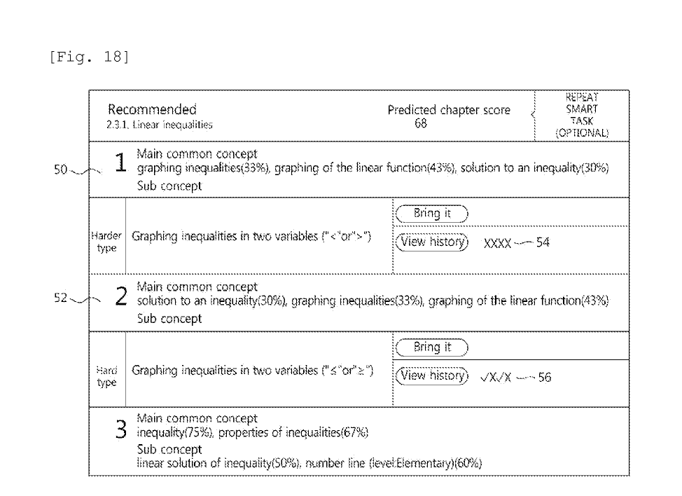

FIG. 18 illustrates an example of a page in a recommended order learning step according to an embodiment of the present invention. The recommended order learning step, which is the Recommended step (S48) after the finishing step (S46) of FIG. 13, rearranges an order of question types linked to a corresponding chapter. As a result, the order of learning the question types is adaptively provided to a user so as to raise the learning effect. This step is mainly processed by the question type priority adjusting unit 216 of FIG. 3.

On the page illustrated in FIG. 18, the question types at the same chapter are arranged in a different order from that illustrated in FIG. 9. This order of arranging the question types is determined based on a learning history of each of the question types, in such a way that Question Type 150 having a learning history 54 in which the latest 4 problems are missed is arranged at first and then Question Type 256 having a learning history 56 in which correct, incorrect, correct, and incorrect answers are sequentially submitted is arranged. Especially, if a recommended order learning step is performed for the first time for the corresponding chapter, the recommended order learning step determines priorities of question types depending on a learning result of each of the question types in the Smart Task step.

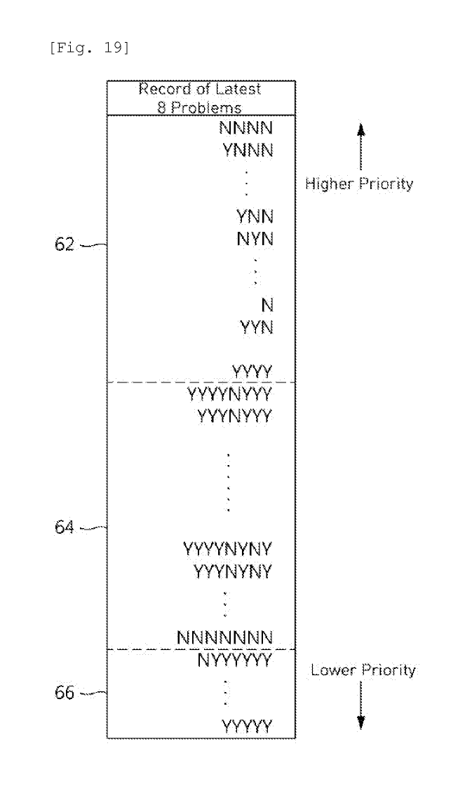

FIG. 19 illustrates a rule for arranging question types in a recommended order learning step according to an embodiment of the present invention. As a result of analysis of accumulated answering patterns by tens of thousands of students, a pattern of correct and incorrect answers for the latest 8 problems may be considered as reliable statistics for determining the degree of understanding a question type. Therefore, a rule for arranging question types according to the embodiment of the present invention is based on the result of answering the latest 8 problems. Because a user may study less than 8 problems for a certain question type, a priority is determined for all the cases from a case in which no problems are studied to a case in which 8 problems are studied.

By analyzing the accumulated data, it is concluded that a case in which 4 or less problems are learned is not sufficient for determining a priority. Therefore, the case in which 4 or less problems are learned is classified into a first group that has the highest priority. Within the first group, a question type that is learned more but has many wrong answers has a higher priority. Next, a second group includes a case in which 5 or more problems are recently learned and one or more wrong answers are submitted for the latest 4 problems. Next, a case in which 5 or more problems are recently learned and all the answers of the latest 4 problems are correct is classified into a third group that has the lowest priority. Statistical analysis tells that in the second and third groups, the record of answering the latest 4 problems is a predominant factor in evaluating learning comprehension. Accordingly, in the second and third group, question types are arranged at first according to the pattern of correct and incorrect answers in the latest 4 problems and then arranged according to the pattern of correct and incorrect answers in the remaining problems.

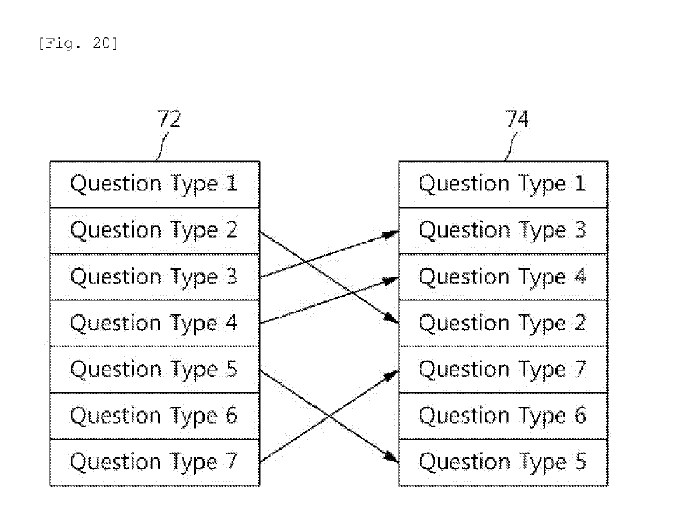

FIG. 20 illustrates a view in which an order of question types is changed in a recommended order learning step according to an embodiment of the present invention. In a certain learning step, question types are arranged from Question Type 1 to Question Type 7 according to the order 72. Then, the records of the latest 8 problems are updated in each of the question types by repeatedly performing the recommended order learning step, so that priorities of question types are changed in the recommended order learning step. As a result, Question Type 2, Question Type 3, Question Type 4, Question Type 5, and Question Type 7 are rearranged, and question types are arranged according to the order 74.

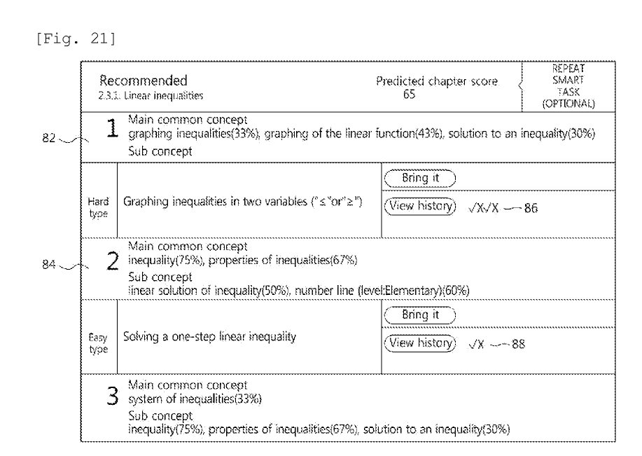

FIG. 21 illustrates an example of a page in a recommend order learning step according to an embodiment of the present invention. In comparison with FIG. 18, a priority of Question Type 1 50 of FIG. 18 drops down because correct answers have not been submitted for the latest problems; and a priority of Question Type 2 52 of FIG. 18 moves up one spot because additional learning has not been performed. Accordingly, in FIG. 20, Question Type 2 84, which is a new question type, is arranged in the second place. As mentioned above, the recommended order learning step adaptively rearranges question types in order of priority, according to the latest learning records. Therefore, a user may selectively study from the question type having the highest priority.

As described above, the adaptive learning device and method using question types and relevant concepts, according to the present invention, are not limited to the configurations and methods of foregoing embodiments, but all or a part of the embodiments may be selectively combined so as to be variously changed.

A learning device and a learning method, according to the embodiment of the present invention, are described mainly with mathematics, but may be applied to various fields including history, science, language, and the like, without limitation to mathematics. The scope of the invention is not limited to the embodiments but it should be determined by the accompanying claims.

### INDUSTRIAL APPLICABILITY

The present invention relates to a learning device and method used for education, which may improve efficiency and value of a learning process by enabling a user to experience and learn online various kinds of adaptive education content at schools and homes.

1. An adaptive learning device using question types and relevant concepts which displays learning content in a user's terminal connected by a network, and which processes the learning content provided to a user using a processor and a memory, to assist the user in learning, comprising:
a curriculum storing unit in which learning courses to be provided to a user are stored, the learning courses each being linked to multiple chapters for separating learning steps;
a question type storing unit in which concepts necessary for learning and question types representing problems are stored in connection with the chapter;
a problem type storing unit in which problem types are stored in connection with the question type;
a problem storing unit in which problems are stored in connection with the problem types;
a concept storing unit in which concepts are stored in connection with the problems;
a concept map storing unit in which a relation between the concepts is stored;
a learning history storing unit in which a learning history for each user is stored; and
a processing unit for providing learning content to the user using data stored in the curriculum storing unit, the question type storing unit, the problem type storing unit, the problem storing unit, the concept storing unit, the concept map storing unit, and the learning history storing unit,
wherein each user's learning history of the problem is connected with the chapter, the question type, the problem type, and one or more of the concepts, and
wherein the processing unit comprises: an adaptive problem extracting unit in which a problem to be provided to a user is extracted according to a rule for multiple learning levels each, which is established based on an interconnected structure in the question type storing unit, the problem type storing unit, the problem storing unit, the concept storing unit, and the concept map storing unit; a question type priority adjusting unit in which a priority of the multiple question types to be provided to a user is adjusted according to each user's learning history stored in the learning history storing unit; and a cloud map output unit that provides a cloud map to the user's terminal, using a concept and a relevant concept extracted from the concept storing unit and the concept map storing unit.

2. The adaptive learning device of claim 1, wherein the concept map storing unit stores one or more previous concepts and one or more next concepts in connection with the concept stored in the concept storing unit.

3. The adaptive learning device of claim 2, wherein the concept map storing unit stores linking strength between relevant concepts.

4. The adaptive learning device of claim 1, wherein the question type is connected with multiple problem types, which are stored in the problem type storing unit and a sequence is assigned to, and each of the problem types is connected with both a representative problem and multiple similar problems, which are part of the problems stored in the problem storing unit.

5. The adaptive learning device of claim 1, wherein the adaptive problem extracting unit extracts a problem based on a target score, and according to a rule for determining a number of problems to be extracted, which is defined for each question type level of the question type stored in the question type storing unit.

6. The adaptive learning device of claim 5, wherein the question type priority adjusting unit provides a user with a recommended order learning by adjusting a priority of the question type according to the user's learning history for the problem extracted by the adaptive problem extracting unit.

7. An adaptive learning method using question types and relevant concepts, which displays learning content in a user's terminal connected by a network, and which processes and provides the learning content using a processor and a memory to assist the user in learning, wherein the adaptive learning method comprises a learning method using a learning device comprising:
a curriculum storing unit in which learning courses to be provided to a user are stored, the learning courses each being linked to multiple chapters for separating learning steps;
a question type storing unit in which concepts necessary for learning and question types representing problems are stored in connection with the chapter;
a problem type storing unit in which problem types are stored in connection with the question type;
a problem storing unit in which problems are stored in connection with the problem types;
a concept storing unit in which concepts are stored in connection with the problems;
a concept map storing unit in which a relation between the concepts is stored;
a learning history storing unit in which a learning history for each user is stored; and
a processing unit for providing learning content to the user using data stored in the curriculum storing unit, the question type storing unit, the problem type storing unit, the problem storing unit, the concept storing unit, the concept map storing unit, and the learning history storing unit,
wherein the adaptive learning method comprises:
connecting, by the learning history storing unit, the user's learning history of the problem with the chapter, the question type, the problem type, and one or more of the concepts;
adaptively extracting, by the adaptive problem extracting unit, a problem, to be provided to the user, from the problem storing unit, according to a rule for multiple learning levels each, which is established based on an interconnected structure in the question type storing unit, the problem type storing unit, the problem storing unit, the concept storing unit, and the concept map storing unit;
adjusting, by the question type priority adjusting unit, a priority of the multiple question types according to the user's learning history stored in the learning history storing unit; and
providing, by the cloud map output unit, a cloud map to the user's terminal, using a concept and a relevant concept extracted from the concept storing unit and the concept map storing unit.

8. The adaptive learning method of claim 7, further comprising:
storing one or more previous concepts and one or more next concepts in the concept map storing unit in connection with the concept stored in the concept storing unit.

9. The adaptive learning method of claim 8, further comprising:
storing linking strength between relevant concepts in the concept map storing unit.

10. The adaptive learning method of claim 7, wherein the question type is connected with multiple problem types, which are stored in the problem type storing unit and a sequence is assigned to, and each of the problem types is connected with both a representative problem and multiple similar problems, which comprises in the problems stored in the problem storing unit.

11. The adaptive learning method of claim 7, wherein adaptively extracting the problem comprises extracting, based on a target score, a problem according to a rule for determining the number of problems to be extracted, which is defined for each question type level of the question type stored in the question type storing unit.

12. The adaptive learning method of claim 11, wherein adjusting the priority of the multiple question types comprises providing the user with a recommended order learning by adjusting the priority of the question type according to the user's learning history for the problem extracted by the adaptive problem extracting unit.
